(19) United States
(12) Patent Application Publication
(10) Pub. No.: US 2006/0195491 A1
(43) Pub. Date: Aug. 31, 2006

(54) System and method of importing documents into a document management system

(75) Inventors: Carl Clifford Nieland, Lexington, KY (US); Craig Anthony Rudolph, Lexington, KY (US); John Samuel Steele, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/055,875

(22) Filed: Feb. 11, 2005

(51) Int. Cl. G06F 17/30

(52) U.S. Cl. 707/204

(57) ABSTRACT

A system and method of importing a document into a document management system are presented. In an embodiment, the method comprises displaying at a scanning device a list of one or more available profiles, each of the profiles being associated with metadata; receiving input indicative of a selection of one of the profiles; scanning the document to create a scanned document image; associating the metadata of the selected profile to the scanned document image; and importing the scanned document image and the associated metadata into the document management system.

### FIELD OF THE INVENTION

Embodiments of the invention relate generally to scanning systems and methods. More specifically, embodiments of the invention relate to a scanning system and method of importing documents into a document management system.

### BACKGROUND OF THE INVENTION

In recent years, multifunction devices (MFDs) have come into widespread use in business and home settings. Such devices provide a broader range of functionality than that provided by traditional single-function devices, such as dedicated printers, scanners, copiers, and facsimile machines.

Electronic document management systems (EDMS) are utilized widely in various industries, such as the legal and financial industries. Often, paper documents associated with a particular project or matter are digitally scanned and imported into an EDMS for archival and other purposes. Typically, a scanned document is associated with metadata, some or all of which may be identical to associated metadata of related documents. Barcode coversheets have been employed to facilitate the association of scanned documents with metadata. Such coversheets include or reference applicable metadata for a project or matter. In a typical scenario, a user creates a barcode coversheet at the user's desktop computer using a third party application and then prints the coversheet. At a scanning device, such as an MFD, the user scans the coversheet, and then scans documents the user wishes to associate with the metadata of the coversheet.

### SUMMARY OF THE INVENTION

The following summary sets forth certain example embodiments of the invention described in greater detail below. It does not set forth all such embodiments and should in no way be construed as limiting of the invention.

In an embodiment, a method of using a scanning device to import a document into a document management system comprises displaying at the scanning device a list of one or more available profiles, each of the profiles being associated with metadata; receiving input indicative of a selection of one of the one or more profiles; scanning the document to create a scanned document image; associating the metadata of the selected profile to the scanned document image; and importing the scanned document image and the associated metadata into the document management system.

In another embodiment, a peripheral comprises a display that shows a list of available profiles, each of the profiles having an identifier and being associated with metadata; an interface that receives input indicative of a selected one of the displayed profiles; a scanner that reads a document and generates a graphics image of the document; and a communications interface that sends the graphics image and the metadata associated with the selected profile to a device separate from the peripheral.

### BRIEF DESCRIPTION OF THE DRAWINGS

FIG. 1 shows a system for importing documents into a document management system according to an embodiment of the invention.

FIG. 2 shows a multifunction printer according to an embodiment of the invention.

FIG. 3 shows a screenshot of a user interface according to an embodiment of the invention.

FIG. 4 shows a screenshot of a user interface according to an embodiment of the invention.

FIG. 5 shows a screenshot of a user interface according to an embodiment of the invention.

FIG. 6 shows a screenshot of a user interface according to an embodiment of the invention.

FIG. 7 shows a screenshot of a user interface according to an embodiment of the invention.

FIG. 8 shows a screenshot of a user interface according to an embodiment of the invention.

FIG. 9 shows a screenshot of a user interface according to an embodiment of the invention.

FIG. 10 shows a screenshot of a user interface according to an embodiment of the invention.

FIG. 11 shows a screenshot of a user interface according to an embodiment of the invention.

FIG. 12 shows a process of importing documents into a document management system according to an embodiment of the invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. The order of limitations specified in any method claims does not imply that the steps or acts set forth therein must be performed in that order, unless an order is explicitly identified in the specification as essential. In addition, it should be noted that a plurality of hardware and software based devices, as well as a plurality of different structural components, may be utilized to implement the invention.

Embodiments of the invention relate to a scanning system and method of importing documents into an electronic document management system. In an embodiment, profiles containing metadata can be accessed, modified, and/or created at a multifunction device (MFD). A profile can be selected by a user, and the metadata therein can be associated with scanned documents. It is to be appreciated that embodiments herein do not require desktop application programs (e.g., third party application programs), personal computers, physical barcode coversheets, and other components. Accordingly, embodiments herein achieve significant cost savings to manufacturers and consumers, while expanding the scope of useful functions an MFD can support in a user-friendly manner. Moreover, embodiments herein speed up the process of importing documents into an EDMS, enabling a user to quickly access, create, and/or modify profiles with metadata at an MFD without a need to print and keep track of paper coversheets, and minimizing the time spent by a user profiling documents with applicable metadata.

Additionally, the term “PC” is used generically herein to denote, for example, desktop computers, laptops, servers, and other computers that can be suitably configured to operate within the contexts broadly set forth herein. Further, embodiments of the invention can be applied to printers, copiers, scanners, facsimile devices, multifunction devices, and combination or multifunction printers that perform some or all these functions.

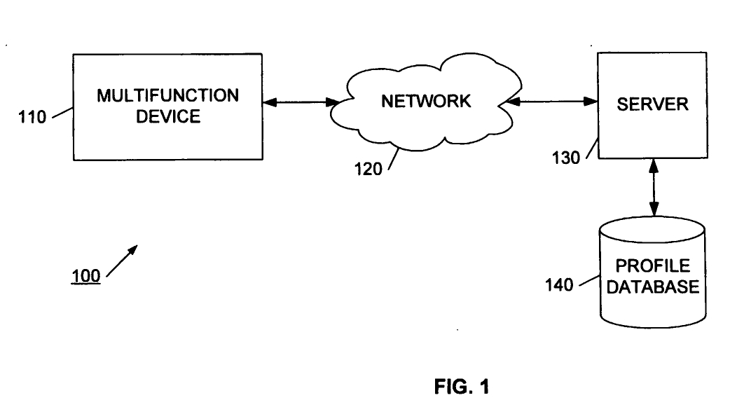

FIG. 1 shows a system 100 for importing documents into an EDMS according to an embodiment of the invention. The system 100 includes an MFD 110, a server 130, and a profile database 140. The MFD 110 communicates with the server 130 over a network 120, such as an intranet. Example industries employing EDMSs include legal, financial, medical, and manufacturing industries.

The MFD 110 includes an interface, such as a touch screen and/or other suitable input/output device(s), such as a keypad and/or an LCD display.

In an embodiment, the server 130 runs a routing application, such as Lexmark Document Distributor offered by Lexmark International, Inc. (Lexington, Ky.). The server 130 includes an EDMS or is in communication with an EDMS.

The profile database 140 may be external or internal to the server 130. In an embodiment, the profile database 140 is an ODBC (Open Database Connectivity) compatible database that can be accessed directly or indirectly by the server 130 and/or the MFD 110 or other network-communicating MFDs.

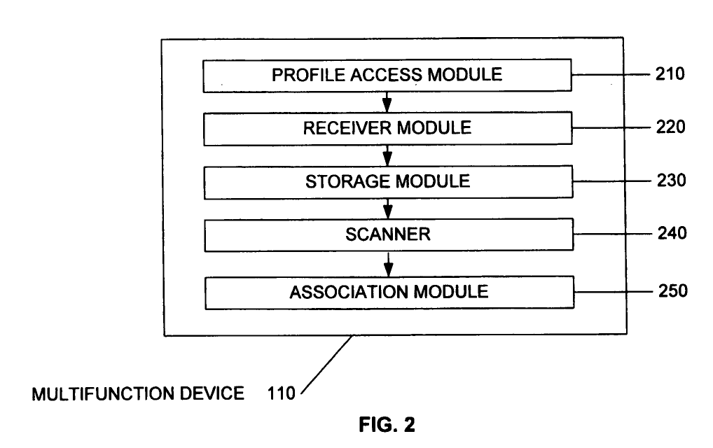

FIG. 2 shows an embodiment of the MFD 110 of FIG. 1. The MFD 110 includes a profile access module 210, a receiver module 220, a storage module 230, a scanner 240, and an association module 250. The modules of the MFD 110 can be implemented in various combinations of hardware, software, and/or firmware. The scanner 240 optionally includes an automatic document feeder (ADF).

The profile access module 210 provides a user at the MFD 110 with access to previously stored profiles (if any). Each profile (also referred to herein as “transaction”) has an identifier and contains or references metadata associated with at least one document. In an example implementation, a profile is the combination of the metadata previously given for a scanned document. The profiles can be stored in the profile database 140 of FIG. 1, accessed by the server 130, and provided to the MFD 110 or other MFDs upon request. In an embodiment, the user is authenticated before being provided with access to profiles. For instance, the user is authenticated after the user logs into the MFD 110 using the credentials of a third party application. In some embodiments, a user identifier can be associated with a profile or group of profiles. To illustrate, in a law firm an attorney will often work on a number of matters, each of the matters being identified by a combination of a client identifier and a matter identifier. In one embodiment of the invention, the attorney has a user identifier that is associated with profiles for each of the client-matter combinations that the attorney works on. Thus, when the attorney enters a valid userid into the MFD, the attorney is presented with a list of profiles, each of the profiles associated with a different client-matter combination. Such relationships among user identifiers enable a correct set of profiles to be presented to the user at the MFD 110. In an embodiment, profiles are not associated with any single MFD. As such, any network-communicating MFD that has been configured with appropriate scripts can access stored profiles.

The MFD 110 also can include a profile presentation module (not shown) that presents a user at the MFD 110 with a list of previously stored profiles (if any). The user can select a desired profile from among the list of profiles.

The receiver module 220 receives a user input that indicates a profile to be associated with a document (e.g., a document related to a legal service, financial service, or other service or purpose) that a user would like to scan and import into the EDMS. Such user input can be provided via a touch screen, keypad, or other suitable input mechanism. The profile can be, for instance, an unaltered profile previously stored, a stored profile that has been modified by the user, and/or a new profile.

The storage module 230 stores the indicated profile in a storage location, such as the profile database 140 and/or a local repository of the MFD 110, if at least one condition is satisfied. For instance, a satisfied condition is the reception of a user input requesting that the profile be saved.

The scanner 240 scans a document to create a scanned document image. The association module 250 associates the scanned document image with the indicated profile. The scanned document image optionally may be processed using optical character recognition (OCR) techniques. Recognized characters in the scanned document image may be used and/or stored, for example, by the MFD 110, the EDMS, or a device in communication with the EDMS.

In an embodiment, the MFD 110 includes a modification interface (not shown) that allows a user to modify settings of stored profiles, create and/or save new profiles, and/or delete profiles.

In an embodiment, if the user has no previously saved profiles, the user is presented with screens of prompts necessary to scan a document into a third party EDMS application. The prompts include questions that solicit answers from the user. At the end of the prompts, the user is given the option to save the user's answers as a profile so that the answers can be used again as metadata for future documents. If the user chooses to save the answers, the user gives the profile a name and then scans the document using the scanner 240.

In an embodiment, if the user had previously saved profiles, the user is presented with a list of the user's profiles in the order of most recently used. If the user selects one of the saved profiles, the user is given a summary display of the metadata (settings) associated with that profile and can choose to change none, one, or multiple of these settings. If the user changes any of these settings, the user can choose to update the current profile with these changes, create a new profile with these changes, or not save these changes. The user can then scan the document using the scanner 240.

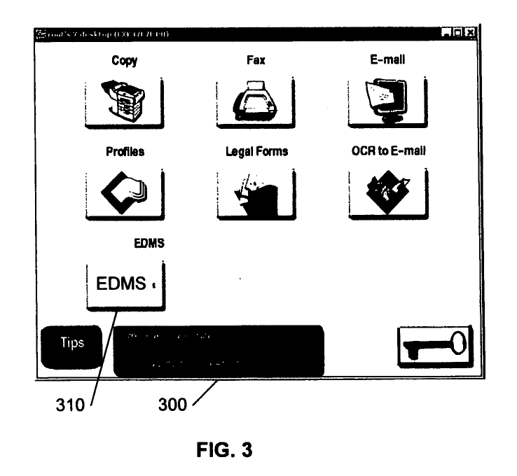

FIGS. 3 to 11 show screenshots of various example MFD interfaces that provide functionality in accordance with embodiments of the invention. The interfaces of FIGS. 3 to 11 may be sequentially presented depending on selections made by a user. It is to be appreciated that the specific look and feel of the interfaces, as well as the sample textual content depicted therein, are not limiting of the invention.

Specifically, FIG. 3 shows a screenshot of a user interface 300 in accordance with an embodiment of the invention. The interface 300 can be part of a touch screen interface, and includes Fax, Copy, E-mail, and other icons. In particular, the interface 300 includes an EDMS icon 310. In an example sequence of events, a user loads a document in the ADF of the scanner 240 or places the document on the glass of the scanner 240. The user then selects the EDMS icon 310 on the interface 300.

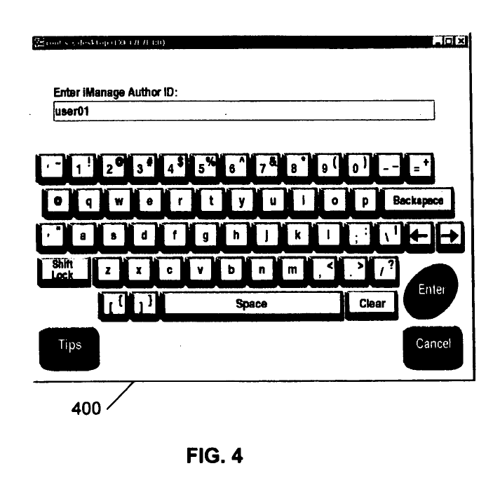

FIG. 4 shows a screenshot of a user interface 400 in accordance with an embodiment of the invention. The interface 400 shows a dialog in the form of a graphical keyboard which allows the user to log into a MFD 110 using, for example, third party authentication credentials.

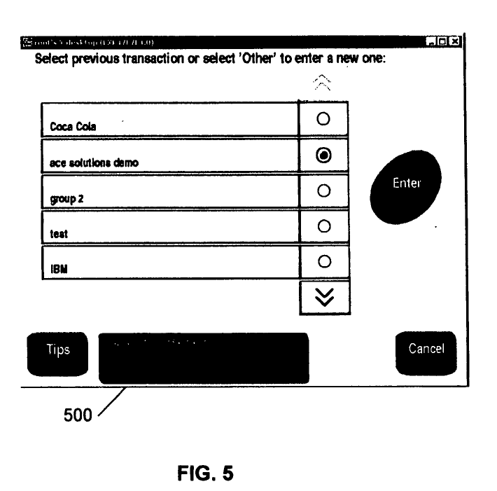

FIG. 5 shows a screenshot of a user interface 500 in accordance with an embodiment of the invention. Because the hypothetical user of FIG. 5 had logged into the system previously and saved at least one profile, the interface 500 presents the user with a list of profiles or transactions from which to choose. If desired, the user can use the down arrow and select Other (not shown) to begin a new transaction from scratch.

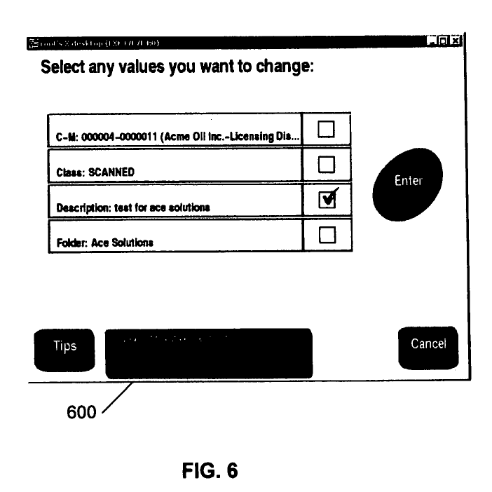

FIG. 6 shows a screenshot of a user interface 600 in accordance with an embodiment of the invention. The interface 600 presents the user with a summary of the data the user previously entered and saved as a profile/transaction. The user can click Enter, and the current document is then scanned with the metadata shown. If the user wants to change any field or combinations of fields, the user selects that field with a checkmark (as shown) and clicks Enter.

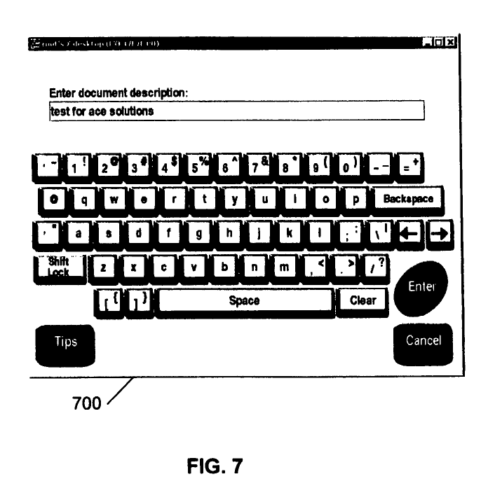

FIG. 7 shows a screenshot of a user interface 700 in accordance with an embodiment of the invention. The interface 700 prompts the user to change the requested field (selected with a checkmark in FIG. 6), which is pre-filled with the previous response. The user makes the desired change and clicks Enter to continue.

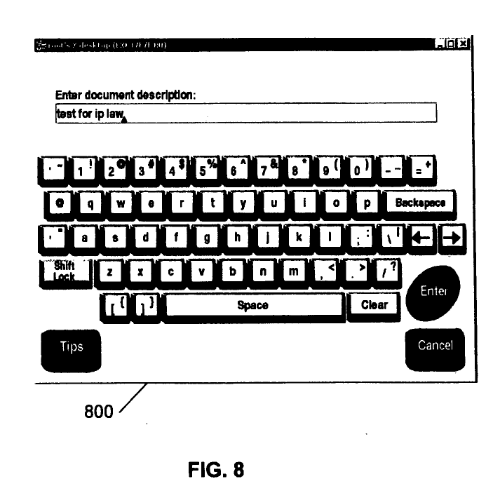

FIG. 8 shows a screenshot of a user interface 800 in accordance with an embodiment of the invention. The interface 800 shows the field changed by a user in FIG. 7.

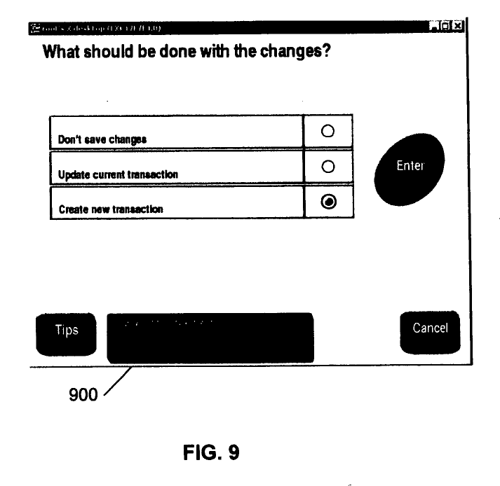

FIG. 9 shows a screenshot of a user interface 900 in accordance with an embodiment of the invention. The interface 900 prompts the user to save changes, update current changes, or create a new transaction. As shown, “Create new transaction” has been selected, and a user can click Enter.

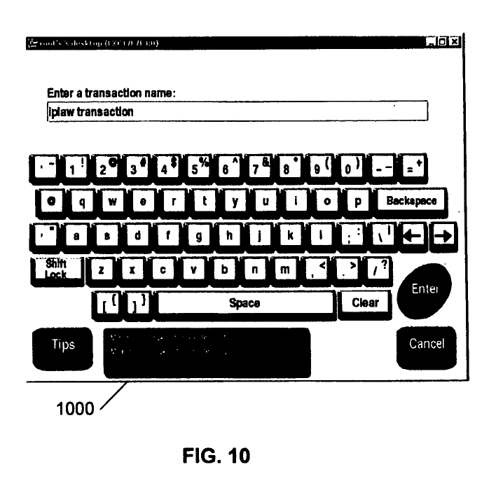

FIG. 10 shows a screenshot of a user interface 1000 in accordance with an embodiment of the invention. Assuming the user in FIG. 9 clicked Enter, the interface 1000 shows a dialog in which the user enters the name of the new transaction and can click Enter to scan the document with the newly captured metadata.

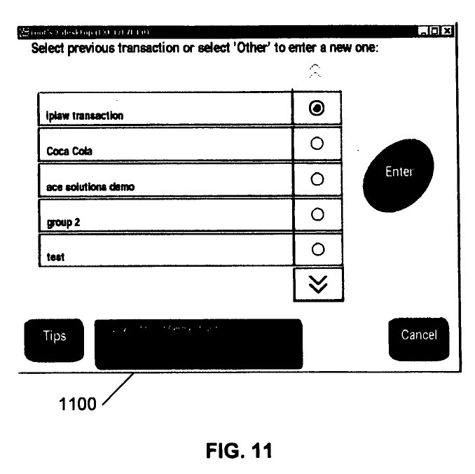

FIG. 11 shows a screenshot of a user interface 1100 in accordance with an embodiment of the invention. When the user next logs into the EDMS system (see FIG. 3) from the MFD 110 or another MFD, the interface 1100 shows the updated profile/transaction list, which includes the newly saved profile/transaction.

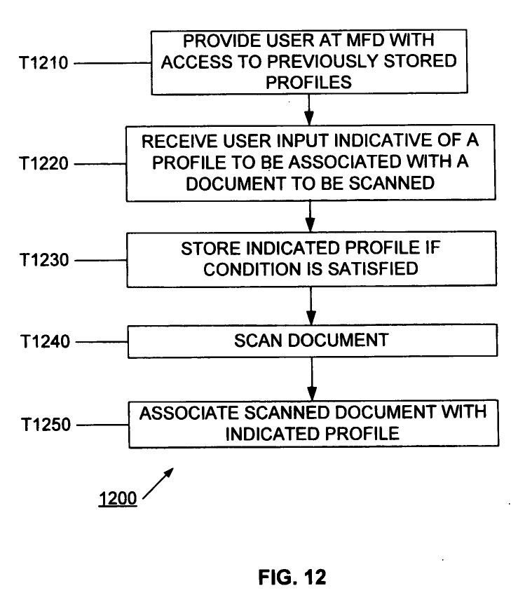

FIG. 12 shows a process 1200 for importing documents into an EDMS according to an embodiment of the invention. The process 1200 can be employed, for instance, in conjunction with various embodiments presented above. Task T1210 provides a user at an MFD with access to previously stored profiles. Task T1220 receives user input indicative of a profile to be associated with a document to be scanned. Task T1230 stores the indicated profile if a condition is satisfied. Task T1240 scans the document. Task T1250 associates the scanned document with the indicated profile.

Alternative embodiments of the invention can be realized. For instance, embodiments herein can coexist with an approach involving barcode coversheets. In addition, it is to be appreciated that embodiments herein can be useful in various contexts, such as any context in which reusable scan metadata is required for scanning documents. Moreover, embodiments are useful in contexts in which scanning can occur over multiple user sessions.

As should also be apparent to one of ordinary skill in the art, the systems shown in the figures are models of what actual systems can be like. As noted, many of the modules and logical structures described are capable of being implemented in software executed by a microprocessor or a similar device or of being implemented in hardware using a variety of components including, for example, ASICs. Terms like “processor” may include or refer to both hardware and/or software. Furthermore, any capitalized terms in the specification are used to conform to common practices and to help correlate the description with the examples and drawings. However, no specific meaning is implied or should be inferred simply due to the use of capitalization. Thus, the claims should not be limited to the specific examples or terminology or to any specific hardware or software implementation or combination of software or hardware.

What is claimed:

1. A method of using a scanning device to import a document into a document management system, the method comprising:
displaying at said scanning device a list of one or more available profiles, each of said profiles being associated with metadata;
receiving input indicative of a selection of one of said one or more profiles;
scanning said document to create a scanned document image;
associating said metadata of said selected profile to said scanned document image; and
importing said scanned document image and said associated metadata into said document management system.

2. The method of claim 1, wherein the step of displaying said list of profiles comprises:
receiving a user identifier; and
displaying only those profiles that are associated with said received user identifier.

3. The method of claim 1, wherein said profiles are stored on said scanning device.

4. The method of claim 1, wherein said profiles are stored on a computing device remote from said scanning device.

5. The method of claim 1, wherein the step of importing said scanned document image and said metadata to said document management system comprises:
sending said scanned document image and said metadata from said scanning device to a remote host, said remote host being used to store data for said document management system; and
adding said scanned document image and said metadata to said stored data for said document management system.

6. The method of claim 1, wherein said profiles are stored in a database remote from said scanning device, said database being accessible by a plurality of peripheral devices via a network.

7. The method of claim 1, further comprising OCR-processing the scanned document image.

8. A peripheral comprising:
a display that shows a list of available profiles, each of said profiles having an identifier and being associated with metadata;
an interface that receives input indicative of a selected one of said displayed profiles;
a scanner that reads a document and generates a graphics image of said document; and
a communications interface that sends said graphics image and the metadata associated with said selected profile to a device separate from said peripheral.

9. The peripheral of claim 8, further comprising one or more memory modules that store said list of available profiles and said associated metadata.

10. The peripheral of claim 9, wherein said one or more memory modules are additionally configured to store said graphics image.

11. The peripheral of claim 8, wherein at least a portion of said available profiles are stored in a device remote from said peripheral.

12. The peripheral of claim 8, further comprising a software module that links said metadata to said graphics image.

13. The peripheral of claim 12, wherein said software module is stored in said peripheral as firmware.

14. The peripheral of claim 8, wherein said display and said interface are configured to allow a user to create a new profile or to modify an existing profile.

15. The peripheral of claim 8, further comprising an authentication module that identifies a user of said peripheral and identifies which of said list of available profiles are associated with said user.

16. The peripheral of claim 8, wherein said communications interface is configured to send said graphics image and said associated metadata to a data store of a document management system.

17. The peripheral of claim 8, further comprising a printer.

18. A scanning system to convert a document into a graphic image and to import said graphic image into a document management system, said scanning system comprising:
a peripheral that scans said document and converts said document to a graphic image, said peripheral configured to display one or more selectable profiles, each of said profiles being associated with metadata, and said peripheral additionally configured to transmit said graphic image and said associated metadata of a selected profile;
a data store in electronic communication with said peripheral device to receive and store said graphic image and said associated metadata; and
a document management system configured to access said data store.

19. The scanning system of claim 18, wherein said peripheral is further configured to OCR-process said graphic image.
